(19) United States
(12) Patent Application Publication
(10) Pub. No.: US 2026/0045416 A1
(43) Pub. Date: Feb. 12, 2026

(54) MULTILAYER BODY, CAPACITOR, ELECTRIC CIRCUIT, CIRCUIT BOARD, DEVICE, AND METHOD FOR PRODUCING MULTILAYER BODY

(71) Applicant: Panasonic Intellectual Property Management Co., Ltd., Osaka (JP)

(72) Inventors: YUYA KATO, Osaka (JP); MANABU KANOU, Osaka (JP)

(21) Appl. No.: 19/363,749

(22) Filed: Oct. 21, 2025

Related U.S. Application Data
(63) Continuation of application No. PCT/JP2024/015009, filed on Apr. 15, 2024.

(30) Foreign Application Priority Data
May 12, 2023 (JP) 2023-079682

(51) Int. Cl. H01G 4/12; H01G 2/06; H01G 4/008

(52) U.S. Cl. CPC H01G 4/1254; H01G 2/065; H01G 4/008

(57) ABSTRACT

A multilayer body includes metallic tantalum, and a dielectric including a first part and a second part. The second part is positioned between the metallic tantalum and the first part. The first part contains tantalum oxide and tin and is positioned at a surface of the dielectric. The second part contains tantalum oxide and is covered with the first part. The content of tin in the first part is higher than the content of tin in the second part.

### BACKGROUND

### 1. Technical Field

The present disclosure relates to a multilayer body, a capacitor, an electric circuit, a circuit board, a device, and a method for producing a multilayer body.

### 2. Description of the Related Art

Materials in which tantalum oxide is doped with tin are known in the related art.

For example, Sangeeta Mahala, Senthil M. Arumugam, Sandeep Kumar, Dalwinder Singh, Shelja Sharma, Bhawana Devi, Sudesh K. Yadav, and Sasikumar Elumalai, Sn Doping on Ta₂O₅ Facilitates Glucose Isomerization for Enriched 5-Hydroxymethylfurfural Production and its True Response Prediction using a Neural Network Model, ChemCatChem 2021, 13, 4787-4798 (Non Patent Literature 1) states that Sn-doped Ta₂O₅ facilitates isomerization of glucose for producing enriched 5-hydroxymethylfurfural (5-HMF). The Sn-doped Ta₂O₅ is produced from a white precipitate obtained by dissolving a sol obtained by suspending tantalum ethoxide in ethanol and stirring in a mixed solvent of ethanol and water, and adding SnCl₄ as a dopant. This white precipitate is, after being ultrasonically washed, treated at 180°C for 6 hours in a hydrothermal reactor. This produces a slurry. A solid separated from this slurry by centrifugation and decantation is washed with ultrapure water until the pH of the supernatant reaches 7.0, and is further washed with ethanol. The washed solid is dried in an oven under conditions of 80°C and 12 hours, and is then heat-treated under conditions of 500°C and 2 hours. Thus, the Sn-doped Ta₂O₅ is synthesized.

### SUMMARY

In one general aspect, the techniques disclosed here feature a multilayer body including metallic tantalum, and a dielectric including a first part and a second part. The second part is positioned between the metallic tantalum and the first part. The first part contains tantalum oxide and tin and is positioned at a surface of the dielectric. The second part contains tantalum oxide and is covered with the first part. The content of tin in the first part is higher than the content of tin in the second part.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view showing an example of a multilayer body of the present disclosure;

FIG. 2 is a sectional view showing an example of a capacitor of the present disclosure;

FIG. 3 is a sectional view showing another example of the capacitor of the present disclosure;

FIG. 4A is a diagram schematically showing an example of an electric circuit of the present disclosure;

FIG. 4B is a diagram schematically showing an example of a circuit board of the present disclosure;

FIG. 4C is a diagram schematically showing an example of a device of the present disclosure;

FIG. 5 is a graph showing results of X-ray photoelectron spectrometry (XPS) measurement on a dielectric film according to Example 1;

FIG. 6 is a graph, in time-of-flight secondary ion mass spectrometry (TOF-SIMS) on the dielectric film according to Example 1, showing the relation between the signal intensity of Sn⁺, TaO⁺, and O⁺ and depth in the dielectric film; and

FIG. 7 is a graph showing the relation between the capacitance of capacitors including dielectric films according to Example 1 and Comparative Example 1 and frequency.

### DETAILED DESCRIPTIONS

One non-limiting and exemplary embodiment provides a multilayer body including a novel dielectric containing tantalum oxide and tin. Underlying Knowledge Forming Basis of the Present Disclosure

Since tantalum oxide has a high relative dielectric constant, it is widely used as a dielectric material for high-performance capacitors. In recent years, along with improved performance of electronic devices, capacitors having a higher capacitance have been demanded, and it is also important to further increase the capacitance of capacitors including a dielectric material containing tantalum oxide.

Given these circumstances, the present inventors have conducted an intensive study on a component, to be added to a dielectric material containing tantalum oxide, which can increase the capacitance of capacitors including the dielectric material, and the present inventors have focused on the possibility that tin easily causes polarization in an oxide film. The present inventors have conducted a further study and newly found that if the content of tin in a specific part of a dielectric containing tantalum oxide is higher than the content of tin in another part thereof, the capacitance of a capacitor including the dielectric easily increases. As a result, the present inventors have devised the dielectric and the capacitor of the present disclosure.

In the Sn-doped Ta₂O₅ described in Non Patent Literature 1, because of its production method, tin is probably present uniformly in the entirety of this material. Therefore, with the method for producing the Sn-doped Ta₂O₅ described in Non Patent Literature 1, it is believed to be difficult to adjust the content of tin in a specific part of a metal oxide material such that it is higher than the content of tin in another part thereof.

### Embodiment

An embodiment of the present disclosure will be described below with reference to the drawings. The present disclosure is not limited to the following embodiment.

FIG. 1 is a sectional view showing an example of a multilayer body of the present disclosure. As shown in FIG. 1, a multilayer body 100 includes a dielectric 1 and a substrate 2. The dielectric 1 includes a first part 11 and a second part 12. The first part 11 contains tantalum oxide and tin and has a surface 1a of the dielectric 1. The second part 12 contains tantalum oxide and is covered with the first part 11. The content of tin in the first part 11 is higher than the content of tin in the second part 12. With this configuration, although tin is not present uniformly in the entire dielectric 1, the dielectric 1 easily has, for example, advantageous characteristics from the viewpoint of increasing the capacitance of the capacitor. In addition, oxygen defects are unlikely to occur in the dielectric 1 due to tin contained in the first part 11, and the dielectric 1 easily has advantageous characteristics from the viewpoint of increasing the durability of the capacitor.

As shown in FIG. 1, the second part 12 is in contact with the substrate 2. The substrate 2 is not limited to a specific substrate. The substrate 2 is, for example, a conductor. The conductor is, for example, metallic tantalum. In this case, the substrate 2 can function as an electrode of the capacitor. The second part 12 is in contact with, for example, a substrate 2 formed of metallic tantalum. In this case, the dielectric 1 can be formed by anodic oxidation. The substrate 2 may be a dielectric.

The shape of the dielectric 1 is not limited to a specific shape. As shown in FIG. 1, the dielectric 1 forms, for example, a film. In this case, the thickness of the dielectric 1 is not limited to a particular value. The thickness is, for example, greater than or equal to 10 nm and less than or equal to 1,000 nm. The thickness of the dielectric 1 may be determined based on results of TOF-SIMS or determined based on observation of a cross-section of the dielectric 1 using an electron microscope such as a scanning electron microscope (SEM) or a transmission electron microscope (TEM). The dielectric 1 may be in a particle form or a fibrous form.

As shown in FIG. 1, in the dielectric 1, for example, the first part 11 forms a first layer 11a, and the second part 12 forms a second layer 12a. In this case, the relation between a thickness t₁₁ₐ of the first layer 11a and a thickness t₁₂ₐ of the second layer 12a is not limited to a specific relation. The thickness t₁₁ₐ of the first layer 11a is, for example, less than or equal to 24% of a sum S₁₂ of the thickness t₁₁ₐ of the first layer 11a and the thickness t₁₂ₐ of the second layer 12a. Also with this configuration, the dielectric 1 can have advantageous characteristics from the viewpoint of increasing the capacitance of the capacitor. The thickness t₁₁ₐ and the thickness t₁₂ₐ can each be determined based on measurement results of TOF-SIMS, and can be determined, for example, in accordance with the method described in Example.

The thickness t₁₁ₐ of the first layer 11a may be less than or equal to 30%, less than or equal to 25%, less than or equal to 20%, or less than or equal to 15% of the sum S₁₂. The thickness t₁₁ₐ of the first layer 11a is, for example, greater than or equal to 5% of the sum S₁₂.

The distribution of the content of tin in the first part 11 is not limited to a specific distribution. For example, in the first part 11, a content C_{P1} of tin at a first position P1 is lower than a content C_{P2} of tin at a second position P2. The first position P1 is a position separated from the surface 1a by a first distance in a direction perpendicular to the surface 1a in the first part 11. The second position P2 is a position separated from the surface 1a by a second distance in the direction perpendicular to the surface 1a in the first part 11. The second distance is shorter than the first distance. Also with this configuration, the dielectric 1 can have advantageous characteristics from the viewpoint of increasing the capacitance of the capacitor.

In the dielectric 1, the content of tin may continuously decrease or discontinuously decrease as the distance from the surface 1a in the direction perpendicular to the surface 1a increases.

The content of tin in the first part 11 is not limited to a specific value. For example, in TOF-SIMS on the dielectric 1, the intensity of a signal of an ion derived from tin is lower than the signal intensity of an ion derived from tantalum oxide.

The oxidation number of tin contained in the first part 11 is not limited to a specific value. The first part 11 contains, for example, divalent tin. In this case, polarization caused by tin in the dielectric 1 easily becomes large, and the dielectric 1 more easily has advantageous characteristics from the viewpoint of increasing the capacitance of the capacitor. In addition, oxygen defects are less likely to occur in the dielectric 1.

The method for producing the dielectric 1 is not limited to a specific method. The method for producing the dielectric 1 includes, for example, performing anodic oxidation on metallic tantalum in contact with a solution containing tin. With this production method, the dielectric 1 having the content of tin in the first part 11 higher than the content of tin in the second part 12 can be efficiently produced.

In the anodic oxidation in the above production method, for example, metallic tantalum is used as an anode, and platinum is used as a cathode. A predetermined voltage is applied between the anode and the cathode. This causes anions such as oxide ions attracted toward the metallic tantalum as the anode to combine with ionized tantalum to produce a dielectric containing tantalum oxide. In this process, tin contained in the solution is taken into the dielectric. Therefore, the part forming the surface of the dielectric 1 can contain tin. On the other hand, oxide ions can move to the part of the dielectric 1 in contact with the metallic tantalum, but little tin is taken into this part. Thus, although this part contains tantalum oxide, the content of tin in this part is very low.

The dielectric 1 may be produced by a method other than anodic oxidation, such as sputtering. In this case, as the material of the substrate 2, a material other than metallic tantalum may be used.

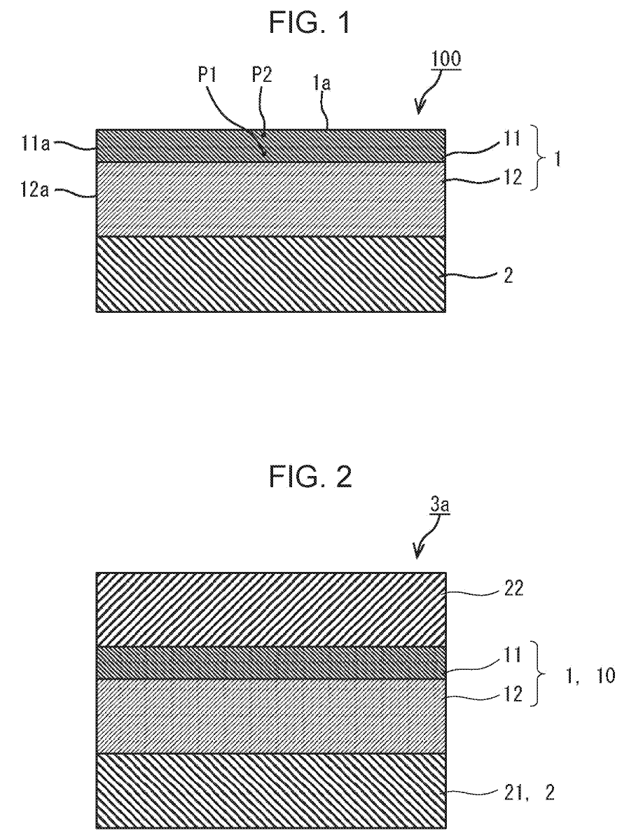

Using the dielectric 1, for example, a capacitor can be provided. FIG. 2 is a sectional view showing an example of the capacitor of the present disclosure. As shown in FIG. 2, a capacitor 3a includes a first electrode 21, a second electrode 22, and a dielectric film 10. The dielectric film 10 includes the dielectric 1, and is disposed between the first electrode 21 and the second electrode 22. With this configuration, the capacitor 3a easily has a high capacitance.

As shown in FIG. 2, the first electrode 21 is in contact with the second part 12 of the dielectric 1. In addition, the first part 11 is disposed between the second part 12 and the second electrode 22 in the thickness direction of the dielectric film 10.

The first electrode 21 contains, for example, metallic tantalum. In this case, the capacitor 3a can be produced by anodic oxidation using a solution containing tin. The first electrode 21 may be a conductor other than metallic tantalum.

The material of the second electrode 22 is not limited to a specific material so long as it has conductivity. The second electrode 22 may contain a valve metal such as aluminum, tantalum, niobium, or bismuth, a precious metal such as gold or platinum, or nickel. The second electrode 22 may contain a carbon material such as graphite.

In the capacitor 3a, the surface 1a of the dielectric 1 may be in contact with an electrolyte. In this case, the second electrode 22 may contain an electrolyte. This electrolyte is not limited to a specific electrolyte. The electrolyte contains, for example, at least one selected from the group consisting of an electrolyte solution, a solid electrolyte, and a conductive polymer. Examples of the conductive polymer include polypyrrole, polythiophene, polyaniline, and derivatives of these. The electrolyte may be a manganese compound such as manganese oxide.

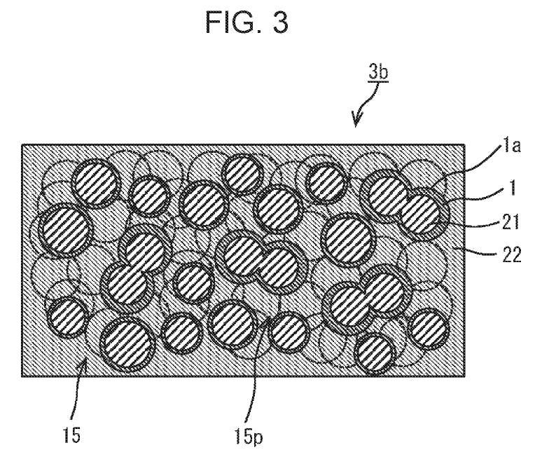

FIG. 3 is a sectional view showing another example of the capacitor of the present disclosure. A capacitor 3b shown in FIG. 3 has the same configuration as the capacitor 3a except the parts specifically described. The components of the capacitor 3b that are the same as or correspond to the components of the capacitor 3a are denoted by the same symbols, and detailed descriptions thereof are omitted. The description about the capacitor 3a also applies to the capacitor 3b so long as there are no technical contradictions.

As shown in FIG. 3, in the capacitor 3b, the dielectric 1 and the first electrode 21 form a porous body 15. The second electrode 22 fills pores 15p in the porous body 15. With this configuration, the area of the first electrode 21 is larger, and the capacitor 3b easily has a higher capacitance.

The porous body 15 is obtained by, for example, performing anodic oxidation on metallic tantalum having a porous structure in contact with a solution containing tin. The metallic tantalum having a porous structure is obtained by, for example, etching treatment on metallic tantalum foil, sintering of metallic tantalum powder, or the like.

In the capacitor 3b, the second electrode 22 contains, for example, an electrolyte. The electrolyte contains, for example, at least one selected from the group consisting of an electrolyte solution, a solid electrolyte, and a conductive polymer. Examples of the conductive polymer include polypyrrole, polythiophene, polyaniline, and derivatives of these. The electrolyte may be a manganese compound such as manganese oxide.

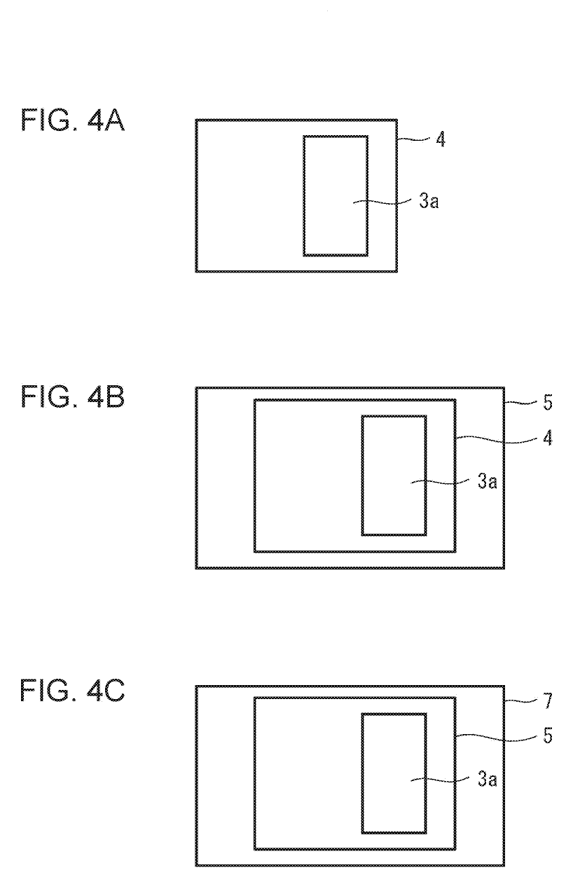

FIG. 4A is a diagram schematically showing an example of an electric circuit of the present disclosure. An electric circuit 4 includes the capacitor 3a. The electric circuit 4 may be an active circuit or a passive circuit. The electric circuit 4 may be a discharge circuit, a smoothing circuit, a decoupling circuit, or a coupling circuit. Since the electric circuit 4 includes the capacitor 3a, the electric circuit 4 easily exhibits desired performance. For example, in the electric circuit 4, noise is easily reduced. The electric circuit 4 may include the capacitor 3b.

FIG. 4B is a diagram schematically showing an example of a circuit board of the present disclosure. As shown in FIG. 4B, a circuit board 5 includes the capacitor 3a. For example, in the circuit board 5, the electric circuit 4 including the capacitor 3a is formed. Since the circuit board 5 includes the capacitor 3a, the circuit board 5 easily exhibits desired performance. The circuit board 5 may be an embedded board or a motherboard. The circuit board 5 may include the capacitor 3b.

FIG. 4C is a diagram schematically showing an example of a device of the present disclosure. As shown in FIG. 4C, a device 7 includes the capacitor 3a. The device 7 includes, for example, the circuit board 5 including the capacitor 3a. Since the device 7 includes the capacitor 3a, the device 7 easily exhibits desired performance. The device 7 may be an electronic device, a communication device, a signal processing apparatus, or a power supply apparatus. The device 7 may be a server, an AC adaptor, an accelerator, or a flat panel display such as a liquid crystal display (LCD) apparatus. The device 7 may be a USB charger, a solid-state drive (SSD), a PC, a smartphone, an information terminal such as a tablet PC, or an Ethernet switch. The device 7 may include the capacitor 3b.

### Appendix

The following techniques are disclosed by the above description.

### Technique 1

A multilayer body including:

metallic tantalum; and

a dielectric including a first part and a second part, wherein

the second part is positioned between the metallic tantalum and the first part,

the first part contains tantalum oxide and tin and is positioned at a surface of the dielectric,

the second part contains tantalum oxide and is covered with the first part, and

a content of tin in the first part is higher than a content of tin in the second part.

### Technique 2

The multilayer body according to Technique 1, wherein

the first part has a first layer shape,

the second part has a second layer shape, and

a thickness of the first part is less than or equal to 24% of a sum of the thickness of the first part and a thickness of the second part.

### Technique 3

The multilayer body according to Technique 1 or 2, wherein in the first part, a content of tin at a first position separated from the surface by a first distance in a direction perpendicular to the surface is lower than a content of tin at a second position separated from the surface by a second distance shorter than the first distance in the direction.

### Technique 4

The multilayer body according to any one of Techniques 1 to 3, wherein the tin contained in the first part contains divalent tin.

### Technique 5

A capacitor including:

a first electrode;

a second electrode; and

a dielectric film disposed between the first electrode and the second electrode and including a first part and a second part, wherein

the first electrode contains metallic tantalum,

the second part is positioned between the first electrode and the first part,

the first part contains tantalum oxide and tin and is positioned at a surface of the dielectric film,

the second part contains tantalum oxide and is covered with the first part, and

a content of tin in the first part is higher than a content of tin in the second part.

### Technique 6

An electric circuit including the capacitor according to Technique 5.

### Technique 7

A circuit board including the capacitor according to Technique 5.

### Technique 8

A device including the capacitor according to Technique 5.

### Technique 9

A method for producing a multilayer body, the method including:

bringing metallic tantalum into contact with a solution containing tin; and

performing anodic oxidation on the metallic tantalum in contact with the solution.

### Example

The present disclosure will be described below in more detail with reference to an example. Note that the following example is illustrative, and the present disclosure is not limited to the following example.

### Example 1

A tantalum plate having a thickness of 0.1 mm was prepared as an anode. This tantalum plate had a rectangular shape having short sides of 10 mm and long sides of 50 mm in plan view. A sheet of tantalum foil having a surface area about a few times larger than that of this tantalum plate was prepared as a cathode. The tantalum plate and the tantalum foil were ultrasonically washed in acetone for 10 minutes, and were then washed with water. The tantalum plate and the tantalum foil were placed in an aqueous solution containing K₂SnO₃ with a predetermined spacing. The concentration of K₂SnO₃ in the aqueous solution was 0.1 mol/L. Next, using a power supply apparatus, a constant voltage was applied between the tantalum plate as the anode and the tantalum foil as the cathode to cause an electrochemical reaction on the surface of the tantalum plate, thus performing anodic oxidation. This formed a dielectric film on the tantalum plate. In the anodic oxidation, a DC stabilized power supply was used as the power supply apparatus, and a current value during the formation of the dielectric film was measured with a digital multimeter. The voltage in the anodic oxidation was raised at a rate of 20 V/minute, and after reaching 80 V, this voltage was maintained at 80 V for 90 minutes. After the voltage application, the dielectric film formed on the tantalum plate was washed with flowing water for 15 minutes. Thus, a dielectric film according to Example 1 was obtained.

### Comparative Example 1

A dielectric film according to Comparative Example 1 was obtained in the same manner as in Example 1 except that an aqueous solution containing H₃PO₄ was used instead of the aqueous solution containing K₂SnO₃. The concentration of H₃PO₄ in this aqueous solution was 0.0017 mol/L.

### Elemental Composition Analysis

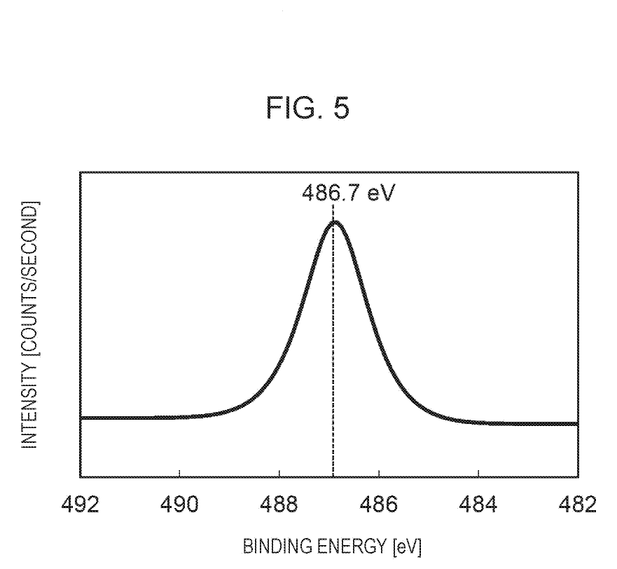

Using PHI 5000 VersaProbe, an XPS measurement apparatus manufactured by ULVAC-PHI, Inc., XPS measurement was performed in order to perform composition analysis on the dielectric film according to Example 1. In this measurement, the MgKα line (1,253.6 eV) was used as a characteristic X-ray. FIG. 5 is a graph showing results of the XPS measurement on the dielectric film according to Example 1. In FIG. 5, the vertical axis is the intensity of photoelectrons, and the horizontal axis is binding energy. In FIG. 5, fitting on the measured data by the least square method was performed to identify a peak position (486.7 eV) of the graph shown in FIG. 5. Since this peak position is near the peak position of SnO, the oxidation number of tin contained in the dielectric film according to Example 1 is believed to be divalent, which is 2 smaller than tetravalent, which is the highest oxidation number.

### Composition Analysis in Depth Direction

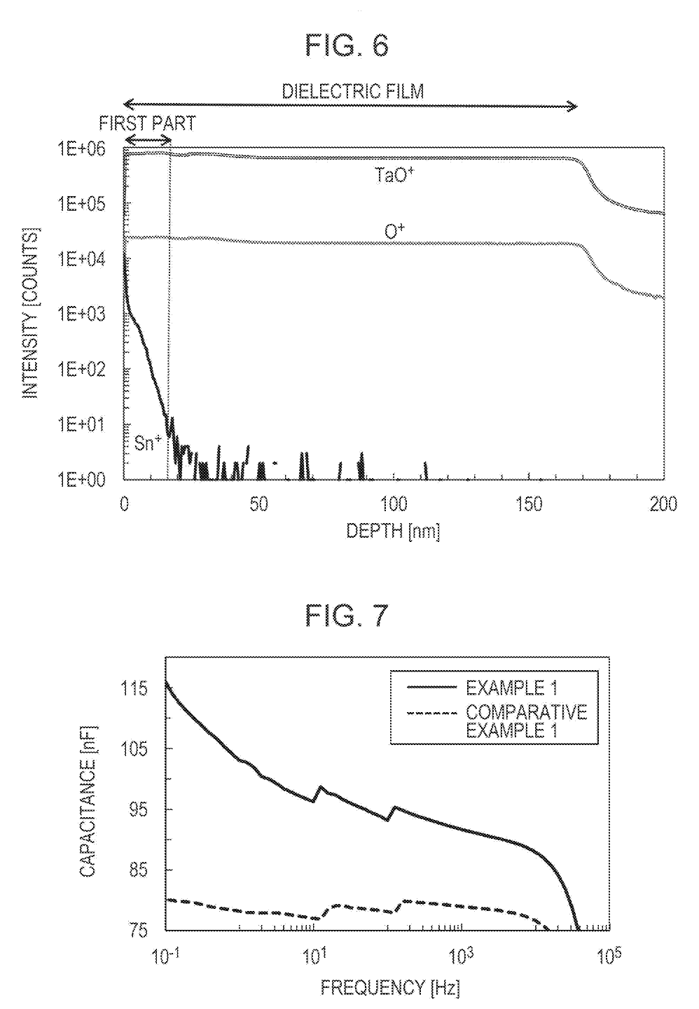

Using TOF.SIMS5, a TOF-SIMS apparatus manufactured by ION-TOF, composition analysis by TOF-SIMS was performed on the dielectric film according to Example 1. In TOF-SIMS, a Bi³⁺ beam accelerated with a voltage of 30 kV was used as an ion beam. Cs⁺ was used as a sputtering ion species. The depth was determined based on a sputter rate. FIG. 6 is a graph, in TOF-SIMS on the dielectric film according to Example 1, showing the relation between the signal intensity of a tin ion (Sn⁺), a tantalum oxide ion (TaO⁺), and an oxygen ion (O⁺) and the depth in the dielectric film. In FIG. 6, the vertical axis is the signal intensity of each ion in TOF-SIMS, and the horizontal axis is the depth of the dielectric film.

According to FIG. 6, the signal intensity of TaO⁺ and O⁺ is nearly constant in a depth range of 0 nm to about 160 nm, and it is understood that tantalum oxide is contained in this range. On the other hand, the signal intensity of Sn⁺ decreases as the depth increases in a depth range of 0 nm to about 20 nm, and is very low in a depth range of greater than or equal to about 20 nm. It is thus understood that the dielectric film containing tantalum oxide is formed so as to have a thickness of about 160 nm, and although tin is present in the first part with a thickness of about 20 nm from the surface of the dielectric film, almost no tin is present in another part which corresponds to the second part.

In FIG. 6, the signal intensity of TaO⁺ and O⁺ is nearly constant in a depth range of 0 nm to about 160 nm, whereas the signal intensity of Sn⁺ decreases as the depth increase in a depth range of 0 nm to about 20 nm, which corresponds to the first part, and is very low in a depth range of greater than or equal to about 20 nm, which corresponds to the second part. It can be seen from this that the content of tin in the first part is higher than the content of tin in the second part.

### Dielectric Characteristics

Using the tantalum plates on which the dielectric films were formed according to Example 1 and Comparative Example 1, AC impedance measurement was performed. This measurement was performed in an aqueous phosphoric acid solution with a concentration of 1 mol/L using a potentiostat and galvanostat. With the amplitude of voltage adjusted to 100 mV, an AC voltage was applied between a pair of electrodes including the tantalum plate in a range of 0.1 Hz to 1 MHz. Based on results of the AC impedance measurement, the capacitance of a capacitor including the dielectric film was calculated. The AC impedance measurement was performed in an environment at room temperature.

FIG. 7 is a graph showing the relation between the capacitance of capacitors including the dielectric films according to Example 1 and Comparative Example 1 and frequency. In FIG. 7, the vertical axis shows capacitance, and the horizontal axis shows the frequency of the AC voltage. As shown in FIG. 7, the capacitance of the capacitor including the dielectric film according to Example 1 was larger than the capacitance of the capacitor including the dielectric film according to Comparative Example 1. It has thus been suggested that it is advantageous in view of increasing the capacitance of the capacitor that tin be contained in the part forming the surface of the dielectric containing tantalum oxide. As described above, since the oxidation number of tin contained in the dielectric is believed to be divalent, it is probable that structural asymmetry occurs to easily cause polarization, which may contribute to the achievement of the high capacitance.

The multilayer body according to the present disclosure can be used for electronic components such as capacitors.

WHAT IS CLAIMED IS:

1. A multilayer body comprising:
metallic tantalum; and
a dielectric including a first part and a second part, wherein
the second part is positioned between the metallic tantalum and the first part,
the first part contains tantalum oxide and tin and is positioned at a surface of the dielectric,
the second part contains tantalum oxide and is covered with the first part, and
a content of tin in the first part is higher than a content of tin in the second part.

2. The multilayer body according to claim 1, wherein
the first part has a first layer shape,
the second part has a second layer shape, and
a thickness of the first part is less than or equal to 24% of a sum of the thickness of the first part and a thickness of the second part.

3. The multilayer body according to claim 1, wherein in the first part, a content of tin at a first position separated from the surface by a first distance in a direction perpendicular to the surface is lower than a content of tin at a second position separated from the surface by a second distance shorter than the first distance in the direction.

4. The multilayer body according to claim 1, wherein the tin contained in the first part contains divalent tin.

5. A capacitor comprising:
a first electrode;
a second electrode; and
a dielectric film disposed between the first electrode and the second electrode and including a first part and a second part, wherein
the first electrode contains metallic tantalum,
the second part is positioned between the first electrode and the first part,
the first part contains tantalum oxide and tin and is positioned at a surface of the dielectric film,
the second part contains tantalum oxide and is covered with the first part, and
a content of tin in the first part is higher than a content of tin in the second part.

6. An electric circuit comprising the capacitor according to claim 5.

7. A circuit board comprising the capacitor according to claim 5.

8. A device comprising the capacitor according to claim 5.

9. A method for producing a multilayer body, the method comprising:
bringing metallic tantalum into contact with a solution containing tin; and
performing anodic oxidation on the metallic tantalum in contact with the solution.
